(19) United States
(12) Patent Application Publication
(10) Pub. No.: US 2026/0046179 A1
(43) Pub. Date: Feb. 12, 2026

(54) LOW-POWER STATE EXIT SKEW REDUCTION

(71) Applicant: Intel Corporation, Santa Clara, CA (US)

(72) Inventors: Michelle JEN, Los Altos, CA (US); Bruce Allen TENNANT, Hillsboro, OR (US); Shamnad SN, Bangalore (IN); Debendra DAS SHARMA, Saratoga, CA (US)

(21) Appl. No.: 19/090,481

(22) Filed: Mar. 26, 2025

(51) Int. Cl. H04L 25/03; H04B 1/18; H04L 25/02

(52) U.S. Cl. CPC H04L 25/03866; H04B 1/18; H04L 25/0272

(57) ABSTRACT

A first device includes a first receiver, configured to receive a first signal from a second device over a first connection, corresponding to a first channel, and a second receiver, configured to receive a second signal from the second device over a second connection, corresponding to a second channel; the first receiver includes a first scrambler and a first block counter, and the second receiver includes a second scrambler and a second block counter; and wherein, in response to receiving an instruction to transition the second receiver from a low power state to an active state, the first device is configured to set the second scrambler based on a known relationship between the first scrambler and the second scrambler, and to resolve a skew based on a difference between the first block counter and the second block counter.

### BACKGROUND

Ultra Path Interconnect eXtended Interface (UXI) is a low-latency coherent interconnect, which may be used in, for example, scalable multiprocessor systems. Similar to Peripheral Component Interconnect Express (PCIe) 6.0 or Compute Express Link CXL 3.0, UXI (which may also be referred to as Ultra Path Interconnect (UPI) 3.0) introduced the use of a low-power state (L0p). In this manner, one or more lanes of the UXI interface can be caused to enter L0p, which allows for a dynamic adjustment of the UXI interface to become less than the original configured width. This may be achieved dynamically in a UXI connection, such as, for example, in response to current bandwidth needs. In this manner, fewer than all lanes operate concurrently to provide less than maximum bandwidth, while the remaining lanes remain in a power-savings state.

UXI additionally introduced an asymmetric L0p mode in which the number of active transmission (Tx) lanes in a first link direction can differ from the number of active Tx lanes in a second link direction. L0p entry, as used herein, refers to the process of reducing the number of active lanes, while L0p exit, as used herein, refers to the process of increasing the number of active lanes (e.g., transitioning a lane in a reduced power state to an active lane). An activating lane, as used herein, refers to a lane transitioning from a power savings state to active state during L0p exit. As part of L0p exit, a device must ensure that the scramblers or descramblers on its receive path are synchronized with the scramblers of its link partner's transmitter for each of the activating lanes. One of the challenges of this task is the lane-to-lane skew and the fact that the lane-to-lane skew is likely to change from the time that a link enters L0p to the time it exits L0p . Another challenge is to ensure minimal L0p exit latency, which may be of particular importance in meeting UXI latency requirements.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 depicts one direction of a bidirectional UXI serial link with N lanes;

FIG. 2 depicts a UXI Asymmetric L0p Exit Flow;

FIG. 3 depicts a first device and a second device; and

FIG. 4 depicts a method of resolving a skew of a second connection when transitioning from a low power state to an active state.

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [. . . ], etc.). The phrase “at least one of” with regard to a group of elements may be used herein to mean at least one element from the group including the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [. . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

Clock data recovery (CDR), as described herein, is a process in some high-speed communication systems that is used to ensure accurate data transmission. During CDR, the clock signal is extracted from an incoming data stream to synchronize the receiver with the transmitter, thereby enabling correct interpretation of the received data from the incoming data stream. In essence, because the high-speed data link does not typically transmit a separate clock signal, the clock information is embedded in the data stream using an encoding scheme. The CDR circuit at the receiver uses these embedded clock transitions to regenerate the clock signal in real-time. During the CDR process, the phase of the receiver's local clock must be aligned to match the phase of the incoming data signal, and the receiver's clock must be adjusted to run at the same frequency as the transmitter's clock.

Skew (or lane skew) refers generally to a difference in arrival times of data signals across multiple parallel lanes in a high-speed serial communication link, such as, for example, UXI. Skew occurs when signals transmitted simultaneously from a single source transmitter arrive at slightly different times at the destination. One possible source of skew is CDR, since each lane in a multi-lane link will have its own CDR circuit, which extracts timing information from the incoming data stream as described above. When a link exits a low-power state, the CDR circuits for different lanes may relock at slightly different times, thereby leading to skew. In addition, there are likely to be physical path length differences from the transmitter along the various lanes to the destinations (e.g., descramblers). That is, signals traveling on different lanes may experience different trace lengths, such as, for example, on a printed circuit board (PCB). Even slight variations in path length may result in differences in propagation delay, which creates skew. Temperature variations can generate a temperature-induced signal drift that results in variations of signal timing across lanes, thereby resulting in skew. Skew may also result from transmission medium differences, such as variations in impedance, crosstalk, and signal attenuation across different lanes that thereby introduce timing differences. Skew can also result from the resetting of drift buffers, such as during low-power state transitions (e.g., L0p exit), as the drift buffers otherwise compensate for lane timing differences, and their resetting might temporarily increase skew. Skew may result in data misalignment, increased latency, and problems with signal integrity issues, such as jitter and eye diagram degradation, which can, in turn, increase the difficulty of decoding signals correctly.

During link initialization, training sequences that may include, but are not limited to, training sequence 1 (TS1) and training sequence 2 (TS2) ordered sets, may be conventionally used to measure and correct lane-to-lane skew. Once skew is detected, skew can be somewhat corrected for or compensated for by introducing variable (e.g., deskew) buffers at each receiver (e.g., at each receiving entity at the receive end of the lane). In this manner, the buffers are adjusted to temporarily store incoming bits from each lane and align them before processing. It is also known to use Skip (conventionally written as SKP and used as such herein throughout) Ordered Sets for alignment of incoming data. That is, SKP ordered sets may be periodically inserted into the data stream to serve as synchronization points for re-aligning lanes. If skew changes between L0p entry and L0p exit, the link may conventionally need to wait for the next SKP Ordered Set to realign.

The subject-matter described herein includes a low latency mechanism for synchronizing the (de)scramblers on the receive side of a link with the scramblers on the transmit side of the link for activating lanes during L0p exit. Of note, this synchronization may be achieved even if the lane-to-lane skew changes. Although various aspects of the subject-matter will be described relative to UXI asymmetric L0p exit, the underlying concepts can be more broadly applied to a variety of multichip configurations and should not be understood as being expressly limited to UXI.

The PCIe 6.0 specification specifies that while in L0p, the scrambler on the Transmit and Receive sides associated with all lanes must advance if and only if the scrambler associated with Lane 0 advances. The PCIe 6.0 specification further states that any differences in scrambler synchronization on recently activated lanes can be determined and adjusted on a Skip (SKP) Ordered Set boundary. Using this strategy, and if the lane-to-lane skew changes between L0p entry and L0p exit, the L0p exit process will be stalled until the next SKP ordered set boundary, as the scrambler synchronization will require an adjustment. There is also a high probability that a lane-to-lane skew will change simply due to clock-data-recovery (CDR) relock in addition to other factors such as reset of the drift buffer. Waiting until the next SKP ordered set boundary may introduce an undesirable or unacceptable delay in correcting for or compensating for skew. For example, the SKP Ordered Set insertion interval for 1b/1b encoding at 64 GT/s link speed and Common Clock/SRNS mode is approximately once every 1496 ns. If the L0p exit process happens to begin right after a SKP Ordered Set was inserted, then the exit process can be delayed for close to 1496 ns, which when added to the exit latency of the analog I/O circuitry would result in a total latency that exceeds what is desirable for UXI.

To enable a more rapid synchronization of the scramblers, even despite changes in the skew of one or more lanes, a small block count counter may be implemented on the Tx side of Lane0, and separate block count counters may be implemented on the receive (Rx) side, such as in some or all the lanes. In one configuration, the time when activating lanes may begin to transmit relative to the Tx side block count of Lane0 may be constrained. The End Idle Entry Ordered Set (EIEOS) insertion pattern used during an L0p exit to use as markers to initialize the counter values on the receive (Rx) side may be constrained. The counter values on the Rx side of the activating lanes may be constrained to determine the block skew between Lane0 and each of the activating lanes. This skew information along with Lane0 (de)scrambler value may be used to determine the (de)scrambler value for each of the activating lanes during L0p exit.

In an alternative configuration, additional SKP Ordered Sets may be inserted during the L0p exit process so that the interval between SKP Ordered Sets during L0p exit is small enough that the latency associated with stalling the L0p exit process until the next SKP Ordered Set insertion point would still allow for a desirable overall L0p exit latency.

The principles disclosed herein enable a rapid L0p exit, even if lane-to-lane skew has changed from the time of L0p entry to the time of L0p exit.

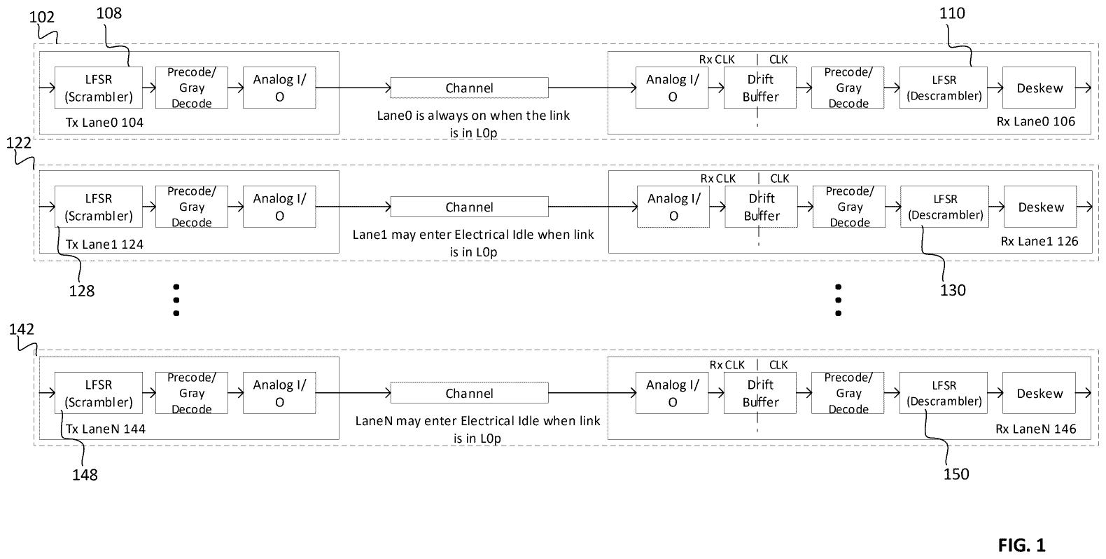

FIG. 1 shows one direction of a bidirectional UXI serial link with N lanes. In this figure, lane 0 102 includes Tx lane(0) 104 and Rx lane(0) 106; lane 1 122 includes Tx lane(1) 124 and Rx lane(1) 126; and lane N 144 includes Tx(n) lane 144 and Rx(n) lane 146. The portions between Tx and Rx lanes are the channel. Each Tx lane is depicted as including a scrambler (which may also be referred to as a linear feedback shift register (LFSR)), a precode or gray decode module, and an analog input/output module. Each Rx lane is depicted as having an analog input/output module, a drift buffer, a precode or gray decode module, a descrambler (which may also be referred to as a linear feedback shift register (LFSR)), and a deskew module. Since detailed description of many of these elements'operation is unnecessary to effectively explain the underlying concepts disclosed herein, only the scramblers or descramblers (collectively referred to herein as scrambles) will be labeled. Tx Lane0 104 includes a first Tx scrambler 108. Lane 0 102 also includes receive lane0 106 (also referred to herein as the first receiver), which includes a first descrambler (also referred to as a first Rx scrambler) 110. Similarly, Lane1 122 includes transmit lane1 124, which includes a second transmit scrambler 128. Lane 1 122 also includes receive lane0 126 (also referred to herein as the second receiver), which includes a second descrambler 130 (also referred to herein as a second Rx scrambler). Finally, LaneN 142 includes transmit laneN 144, which includes an N transmit scrambler 148. LaneN 142 also includes receive laneN 146 (also referred to herein as the N receiver), which includes an N descrambler 150 (also referred to herein as an N Rx scrambler). In this manner, the transmitter may transmit from Tx Lane0 104 to the first Rx lane 106, from Tx Lane1 124 to Rx Lane1 126, and from Tx LaneN 144 to Rx LaneN 146. Obviously, N is used here as an integer variable, and the number of lanes (e.g., the N) may be selected for the given implementation. The communication may be performed according to a transmission protocol such as, PCIe (e.g., UXI).

According to the PCIe specification, when a lane is active, the LFSRs (e.g., the scramblers) on the Tx side and the Rx side are synchronized, since they are initialized to their seed values on transmit or receipt of an EIEOS, advanced after transmit or receipt of a data block or an rdered set other than a SKP ordered set, and readjusted to account for dynamic skew changes on receipt of a SKP ordered set.

When the link enters L0p , Lane0 always remains active while one or more of the other lanes enter a low power state. This means that the LFSRs for Lane0 are always in sync with each other. An inactive lane, i.e., a lane that has entered low power state, cannot keep its LFSRs in sync by relying on transmitted data. The PCIe specification states that the LFSRs on the transmit and receive side for an inactive lane must advance if and only if the scrambler on Lane0 advances. If the skew between Lane0 and the inactive lane has not changed from the time when the lane enters low power state to when it exits low power state, then this is sufficient to ensure the LSFRs remain in sync. In reality, the skew is likely to change during this period due to several factors. When the CDR relocks to generate the receiver's clock signal (e.g. RxCLK) after a lane exits the electrical idle state, this processor is likely to change the skew. Additionally, if the drift buffer (e.g., the elastic buffer) for the lane had a different number of entries when it enters lower power state than it had at reset, the skew between lanes would change due to drift buffer reset when exiting low power state. This means that there is a high probability that the transmit and receive LFSRs would not be in sync for a newly activated lane without further adjustment. The PCI specification indicates that this adjustment can occur upon receipt of the next SKP ordered set. The next SKP ordered set, however, is conventionally sent approximately once every 1496 ns for 1b/1b encoding at a 64 giga transfer (GT) per second (64 GT/s) link speed and a common clock mode or Separate Reference Clock with No Spread Spectrum (SRNS) mode.

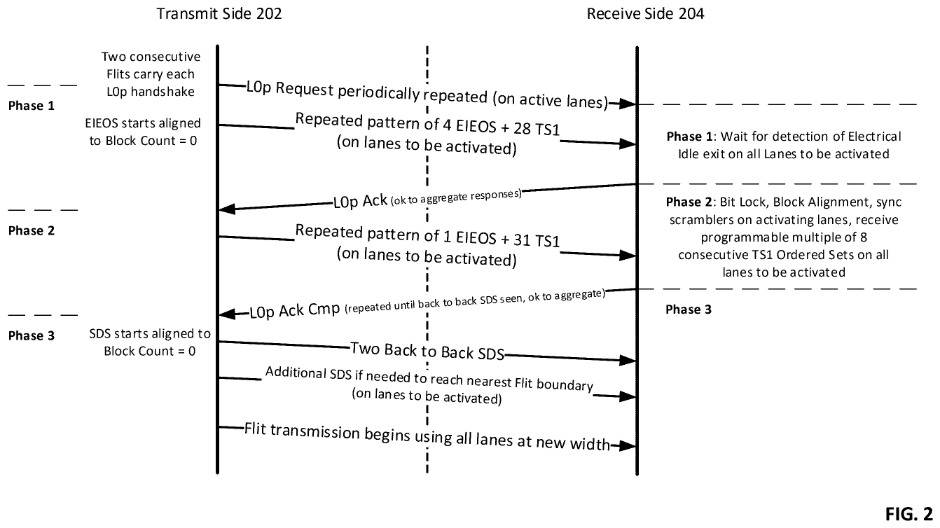

FIG. 2 depicts a UXI Asymmetric L0p Exit Flow. The left portion of this figure represents the transmit side (e.g., communication from a transmitter) 202, and the right portion of this figure represents the receiver side (e.g., communication across a lane to reach a destination, where the received transmission will be descrambled and processed) 204. The first, third, and fifth lines from the top indicate Flits that are striped across currently active lanes. The second, fourth, sixth, and seventh lines from the top indicate patterns to be transmitted on each activating lane. In the first line, the transmit side 202 periodically sends an L0p (low power) request (on active lanes). In Phase 1, the transmit side 202 sends a repeated pattern of 4 EIEOS communications followed by 28 TS1 communications on all lanes to be activated. The receive side 204 sends an acknowledgement of this repeated pattern. In phase two, the transmit side 202 sends a repeated pattern of 1 EIEOS communication plus 31 TS1 communications (on all lanes to be activated), and the receive side 204 sends an acknowledgement. In phase three, the transmit side 202 sends two back to back SDS transmissions, followed by any additional SDS transmissions that are needed to reach the nearest Flit boundary (on the lanes to be activated). The Flit transmission then begins using all lanes that the new width.

Of note, on the transmit side, the Tx Block Count counter is implemented on Lane0. On the receive side, a Rx Block Count counter is implemented in each of the lanes. The number of bits used to implement the counters may be selected based on maximum expected lane-to-lane skew. To avoid ambiguity, if the maximum lane-to-lane skew is expected to be Tmaxskew, then the maximum Block Count must be at least (2 * Blocks for Tmaxskew)+1. On the other hand, the number of counter bits should only be as large as needed, and preferably no larger, to accommodate the maximum lane-to-lane skew, as larger counter values would delay L0p exit. In an exemplarity configuration, at 64 GT/s, one block of 128 bits corresponds to 2 ns; a 4-bit Block Count counter that encodes a maximum value of 15 can accommodate a maximum lane-to-lane skew of 14 ns: ((2 * 7 Blocks)+1=15), where 7 blocks corresponds to 14 ns. The following rules apply to initialization and increment of the Block Count counters:

On Lane0, the Tx Block Count counter is initialized to zero on transmit of a SKP OS, and the Rx Block Count counter is initialized to zero on receipt of a SKP OS; the first block after a SKP OS corresponds to Block Count=0.

On a lane in the process of exiting L0p , while in Phase 2 described below, receipt of an EIEOS or receipt of a SKP OS initializes the Rx Block Count counter; the first block after a SKP OS corresponds to Block Count=0 and the first block after an EIEOS corresponds to Block Count=1.

The Block Count counter is incremented every block and rolls over to 0 after it hits a value of 2^{N}−1 where N is the number of bits used to implement the counter.

As shown in FIG. 2, there are three phases in the L0p exit process:

In Phase 1, the Transmit side sends the L0p exit request to the Receive side using the active lanes; it sends a repeated pattern of 4 EIEOS and 28 TS1s (Pattern A) on each of the lanes to be activated. The transmission of the first EIEOS on the lanes to be activated corresponds to Tx Block Count=0. The receive side enters Phase 1 upon receiving the L0p exit request; during this phase, the receive side waits until it detects an electrical idle exit on all the lanes to be activated and then sends an L0p acknowledgment (ACK). The transmit side enters phase 2 after it receives the L0p Ack. The receive side enters phase 2 after it transmits an L0p ACK.

In Phase 2, the Transmit side transitions to sending a repeated pattern of 1 EIEOS and 31 TS1s (Pattern B) on the activating lanes; the transition to the new pattern occurs at a clean boundary between pattern groups without truncating a Pattern A group to begin transmitting Pattern B to avoid interfering with the CDR lock process. Pattern B may be defined to contain the same number of ordered set blocks as pattern A and the number of ordered sets used was constrained to be a “power of 2”; by additionally constraining the maximum block count to be (2^{N}−1), where 2^{N} is less than or equal to the number of ordered set blocks in the pattern groups, the EIEOS in Pattern B automatically aligns with Block Count=0.

In Phase 2, the receive side must achieve bit lock and block alignment if it has not already done so, load the Receive LFSRs on the activating lanes such that they are in sync with the LFSRs on the Tx side, and then wait to receive a programmable multiple of 8 consecutive TS1 Ordered Sets on all lanes to be activated. After these events complete, the Rx side sends an L0p ACK Completion.

To sync the Rx LFSR on an activating lane (Lane A) with the corresponding LFSR on the Tx side, the following steps may be performed. Step 1: Calculate the LFSR value for lane A that corresponds to the current LFSR value in Lane 0. There is a fixed relationship between the LFSR values for each lane based on the initial seeds of each lane, i.e. the LFSR value for lane A can be calculated by advancing the LFSR value for Lane 0 by a fixed number of states. Step 2: Determine if the LFSR value for lane A calculated in Step 1 needs to be adjusted by comparing the Rx block counts.

The receive block count on the activating lane (BlockCountLnA) is compared to the receive block count on Lane0 (BlockCountLn0) to determine the distance between the two values and to determine whether the LFSR on LaneA should be in sync with the LFSR on Lane0, adjusted forward X states relative to the LFSR on Lane0, or adjusted backwards X states relative to the LFSR on Lane0. MaxBlockCount=(2^{N})−1, where N is the number of counter bits implemented. If (BlockCountLnA=BlockCountLn0), then the LFSR on LaneA should be loaded with the LaneA LFSR value that is in sync with current LFSR value on Lane0.

If (BlockCountLn0>BlockCountLnA) and if (BlockCountLn0−BlockCountLnA)>((MaxBlockCount+1)/2), then the LFSR on LaneA should be loaded with the LaneA LFSR value that is adjusted forwards X states relative to the LFSR on Lane0, where X=128*((MaxBlockCount−BlockCountLn0)+1).

If (BlockCountLn0>BlockCountLnA) and if (BlockCountLn0−BlockCountLnA)<((MaxBlockCount+1)/2), then the LFSR on LaneA should be loaded with the LaneA LFSR value that is adjusted backwards X states relative to the LFSR on Lane0, where X=128*(BlockCountLn0−BlockCountLnA). Of note, (BlockCountLn0−BlockCountLnA) can never actually equal ((MaxBlockCount+1)/2) due to the way the counter is sized relative to maximum skew.

If (BlockCountLnA>BlockCountLn0) and if (BlockCountLnA−BlockCountLn0)>((MaxBlockCount+1)/2), then the LFSR on LaneA should be loaded with the LaneA LFSR value that is adjusted backwards X states relative to the LFSR on Lane0, where X=128*((MaxBlockCount−BlockCountLnA)+1).

If (BlockCountLnA>BlockCountLn0) and if (BlockCountLnA−BlockCountLn0)<((MaxBlockCount+1)/2), then the LFSR on LaneA should be loaded with the LaneA LFSR value that is adjusted forwards X states relative to the LFSR on Lane0, where X=128*(BlockCountLnA−BlockCountLn0).

The Tx sides enters Phase 3 after it receives the L0p ACK Completion. The Rx side enters Phase 3 after it transmits an L0p ACK Completion. In Phase3, the Transmit side sends two or more back-to-back SDS Ordered Sets to reach the nearest Flit Boundary before beginning transmission on all lanes. The start of the first SDS transmission aligns with a block on Lane0 where the Block Count=0 to provide an easy reference point for lane-to-lane deskew. In Phase 3, the Receive side must perform lane-to-lane deskew before the receipt of the 2 SDSs.

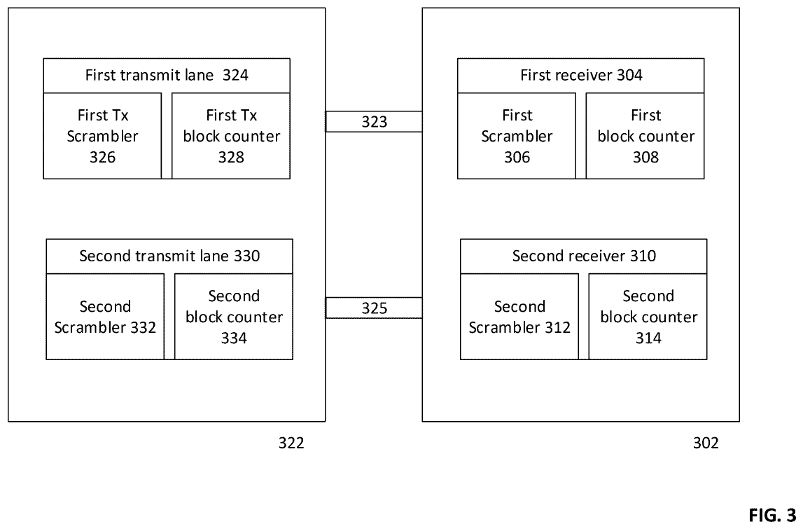

FIG. 3 depicts a first device 302, comprising a first receiver 304, configured to receive a first signal from a second device 322 over a first connection 323, corresponding to a first channel, and a second receiver 310, configured to receive a second signal from the second device 322 over a second connection 325, corresponding to a second channel. The first receiver 304 may include a first scrambler 306 and a first block counter 308, and the second receiver 310 may include a second scrambler 312 and a second block counter 314. In response to receiving an instruction to transition the second receiver 310 from a low power state to an active state, the first device 302 is configured to set the second scrambler 312 based on a known relationship between the first scrambler 306 and the second scrambler 312, to determine, based on a difference between the first block counter and the second block counter, a skew (e.g., a delta of arrival times between the first receiver and the second receiver). The first device 302 may be configured to set its second scrambler 312 based on the determined skew. In this manner, the first device may determine the skew and resolve or compensate for the determined skew.

The known relationship as described above may include any of a value of the first scrambler; any initial seeds of the first scrambler and/or the second scrambler; or a skew among or between lanes that are located between the first and second connection as detected at the second receiver based on a difference between the first block counter and the second block counter. In this manner, a difference between the first block counter and the second block counter may be used to determine and ultimately correct for the skew.

The instruction to transition the second receiver from the low power state to the active state as described above may be any preselected instruction. In one exemplary configuration, the instruction may be or include a plurality of Electrical Idle Exit Ordered Set (EIEOS) transmissions. In this manner, the plurality of EIEOS transmissions may be or include 2^{N} EIEOS transmissions, wherein N is an integer, although this limitation may not be necessary in all configurations. For example, a constraint of 3 would be useable. Similarly, the instruction to transition the second receiver from the low power state to the active state may be or include four EIEOS transmissions followed by twenty-eight repetitions of a training sequence.

In an exemplary configuration, the first device may be configured to determine a block count of a block counter of the second device based on a timing of the instruction. This may be achieved by the first device setting its second block counter to zero upon receiving the instruction. The underlying assumption here is that the second device only sends its instruction when its block counter is at zero and therefore the receipt of the instruction may be a prompt to also set the receiving block counter to zero. This permits for synchronization of the block counters, although this does not, in and of itself, resolve skew. Of course, the zero count is selected for convenience. It would theoretically be possible to create a system in which the second device sends the instruction at any other predetermined block counter count, provided that this predetermined count that corresponds to the sending of the instructions is also known to the receiver.

The first block counter may be configured with a first maximum block count that corresponds to a maximum expected skew among the lane(s) between the first receiver and a transmitter along the first channel. Similarly, the second block counter may be configured with a second maximum block count that corresponds to a maximum expected skew among the lane(s) between the second receiver and the transmitter along the second channel. The skilled person will appreciate that the maximum skew is the delta of arrival time between the first receiver and the second receiver. Skew can be estimated in advance based on the factors related to skew as described above, including, but not limited to CDR relock variability, physical path length differences, and the resetting of the drift buffers that occurs during low power states.

The first block counter may be configured to return to zero after reaching the first maximum block count. Similarly, the second block counter may be configured to return to zero after reaching the second maximum block count. In some configurations, it may be desirable to set the first maximum block count corresponding to a maximum expected skew as the first maximum block count representing a duration that is at least twice the maximum expected skew.

The first device may be configured to determine a block count of a block counter of the second device based on a transmission received following the instruction. In this manner, a total duration of the transmission may be equal to a total duration of the instruction to transition the second connection. In an exemplary configuration, the transmission may include a repeated pattern of one EIEOS followed by thirty-one repetitions of a training sequence.

As stated above, the first device may be configured to resolve or compensate for the skew among lanes of the second connection based on the difference between the first block counter and the second block counter. This compensation may be achieved by determining the skew of the relevant lane(s) and adjusting the scrambler values to account for the determined skew. In this manner, the first device may be configured to determine a value of the second scrambler based on a value of the first scrambler and an expected difference between a value of the first scrambler and a value of the second scrambler. That is, the expected difference may be based on a difference between a value of the first scrambler and a value of the second scrambler during a previous initialization. Determining and resolving or compensating for the skew of the lanes of the second connection may include that the first device compares a value of the first block counter and a value of the second block counter, and if the value of the first block counter is equal to the value of the second block counter, the first device may set the second scrambler to correspond with a current value of the first scrambler.

The first device may determine and resolve or compensate for the skew of the lanes of the second connection by comparing a value of the first block counter and a value of the second block counter, and determining a difference between these values. The first device may then set the second scrambler to a value that is a predetermined number of states forward from a current value of the first scrambler if the value of the first block counter is greater than the value of the second block counter, and if the value of the first block counter minus the value of the second block counter is greater than one-half of an operation of one plus a maximum value of the second block counter. For example, the predetermined number of states forward may be 128*(a maximum block count of the second block counter−a current block count of the first block counter)+1).

The first device may determine and resolve or compensate for the skew of the lanes of the second connection by comparing a value of the first block counter and a value of the second block counter and determining the difference between then, and by setting the second scrambler to a value that is a predetermined number of states backward from a current value of the first scrambler if the value of the first block counter is greater than the value of the second block counter, and if the value of the first block counter minus the value of the second block counter is less than one-half of an operation of one plus a maximum value of the second block counter. In this manner, the predetermined number of states backward may optionally be 128*(a value of the first block counter−a value of the first block counter).

In accordance with the standard, the first device may be configured to reset the second block counter to zero upon receipt of a SKP OS transmission. It is also noteworthy that second block counter includes a maximum block count, and the second block counter is configured to increment upon receipt of a block, unless a current count of the second block counter equals the maximum block count, at which time the second block counter is configured to reset to zero, or to except when it receives the instruction from the second device.

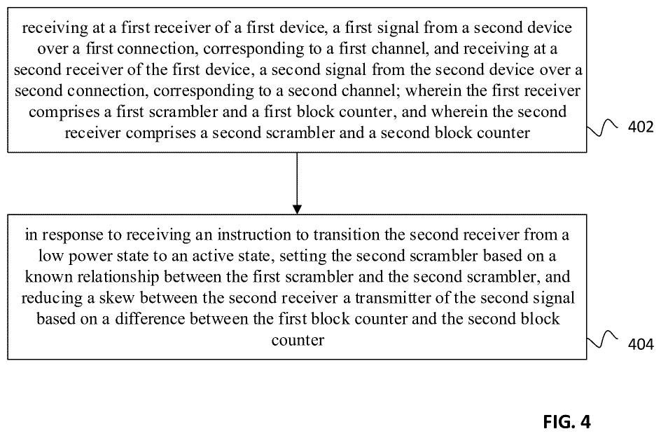

FIG. 4 depicts a method of resolving or compensating for a skew of the lanes of a second connection when transitioning from a low power state to an active state, comprising: receiving at a first receiver of a first device, a first signal from a second device over a first connection, corresponding to a first channel, and receiving at a second receiver of the first device, a second signal from the second device over a second connection, corresponding to a second channel; wherein the first receiver comprises a first scrambler and a first block counter, and wherein the second receiver comprises a second scrambler and a second block counter 402; and in response to receiving an instruction to transition the second receiver from a low power state to an active state, setting the second scrambler based on a known relationship between the first scrambler and the second scrambler, and determining and resolving or compensating for a skew (the arrival time delta between the first receiver and the second receiver) based on a difference between the first block counter and the second block counter 404.

Additional aspects of the disclosure will be provided by way of example:

In Example 1, a first device, comprising a first receiver, configured to receive a first signal from a second device over a first connection, corresponding to a first channel, and a second receiver, configured to receive a second signal from the second device over a second connection, corresponding to a second channel; wherein the first receiver comprises a first scrambler and a first block counter, and wherein the second receiver comprises a second scrambler and a second block counter; and wherein, in response to receiving an instruction to transition the second receiver from a low power state to an active state, the first device is configured to set the second scrambler based on a known relationship between the first scrambler and the second scrambler, and to determine and resolve or compensate for a skew of a lane between the first receiver and a transmitter and a lane between the second receiver and a transmitter of the second signal based on a difference between the first block counter and the second block counter.

In Example 2, the first device of Example 1, wherein the known relationship comprises a value of the first scrambler; initial seeds of the first scrambler and the second scrambler; and a skew between the first and second connection as detected at the second receiver based on a difference between the first block counter and the second block counter.

In Example 3, the first device of Example 2, wherein the instruction to transition the second receiver from the low power state to the active state comprises a plurality of Electrical Idle Exit Ordered Set (EIEOS) transmissions.

In Example 4, the first device of Example 2 or 3, wherein the plurality of EIEOS transmissions comprises 2^{N} EIEOS transmission, wherein N is an integer.

In Example 5, the first device of any one of Examples 2 to 4, wherein the instruction to transition the second receiver from the low power state to the active state comprises four EIEOS transmissions followed by twenty-eight repetitions of a training sequence.

In Example 6, the first device of any one of Examples 1 to 5, wherein first device is configured to determine a block count of a block counter of the second device based on a timing of the instruction.

In Example 7, the first device of Example 6, wherein the first device determining the block count of the block counter of the second device based on the timing of the instruction comprises the first device setting its second block counter to zero upon receiving the instruction.

In Example 8, the first device of any one of Examples 1 to 7, wherein the first block counter is configured with a first maximum block count that corresponds to a maximum expected skew, and wherein the second block counter is configured with a second maximum block count that corresponds to the maximum expected skew.

In Example 9, the first device of Example 8, wherein the first maximum block count corresponding to the maximum expected skew is the first maximum block count representing a duration that is at least twice the maximum expected skew.

In Example 10, the first device of any one of Examples 1 to 9, wherein the first block counter is configured to return to zero after reaching the first maximum block count, and wherein the second block counter is configured to return to zero after reaching the second maximum block count.

In Example 11, the first device of any one of Examples 1 to 10, wherein the first device is further configured to determine a block count of a block counter of the second device based on a transmission received following the instruction.

In Example 12, the first device of Example 11, wherein a total duration of the transmission is equal to a total duration of the instruction to transition the second connection.

In Example 13, the first device of Example 12, wherein the transmission comprises a repeated pattern of one Electrical Idle Exit Ordered Set followed by thirty-one repetitions of a training sequence.

In Example 14, the first device of any one of Examples 1 to 13, wherein the first device being configured to resolve or compensate for the skew of the second connection based on the difference between the first block counter and the second block counter comprises the first device being configured to determine a value of the second scrambler based on a value of the first scrambler and an expected difference between a value of the first scrambler and a value of the second scrambler.

In Example 15, the first device of Example 14, wherein the expected difference is based on a difference between a value of the first scrambler and a value of the second scrambler during a previous initialization.

In Example 16, the first device of any one of Examples 1 to 15, wherein the first device resolving or compensating for the skew of the second connection comprises the first device comparing a value of the first block counter and a value of the second block counter, and if the value of the first block counter is equal to the value of the second block counter, setting the second scrambler to correspond with a current value of the first scrambler.

In Example 17, the first device of any one of Examples 1 to 16, wherein the first device resolving or compensating for the skew of the second connection comprises the first device being configured to compare a value of the first block counter and a value of the second block counter, and setting the second scrambler to a value that is a predetermined number of states forward from a current value of the first scrambler if the value of the first block counter is greater than the value of the second block counter, and if the value of the first block counter minus the value of the second block counter is greater than one-half of an operation of one plus a maximum value of the second block counter.

In Example 18, the first device of Example 17, wherein the predetermined number of states forward is 128*(a maximum block count of the second block counter−a current block count of the first block counter)+1).

In Example 19, the first device of any one of Examples 1 to 18, wherein the first device resolving or compensating for the skew of the second connection comprises the first device being configured to compare a value of the first block counter and a value of the second block counter, and setting the second scrambler to a value that is a predetermined number of states backward from a current value of the first scrambler if the value of the first block counter is greater than the value of the second block counter, and if the value of the first block counter minus the value of the second block counter is less than one-half of an operation of one plus a maximum value of the second block counter.

In Example 20, the first device of Example 19, wherein the predetermined number of states backward is 128*(a value of the first block counter−a value of the first block counter).

In Example 21, the first device of any one of Examples 1 to 20, wherein the first device is configured to reset the second block counter to zero upon receipt of a SKP OS transmission.

In Example 22, the first device of any one of Examples 1 to 21, wherein the second block counter comprises a maximum block count, and wherein the second block counter is configured to increment upon receipt of a block, unless a current count of the second block counter equals the maximum block count, at which time the second block counter is configured to reset to zero, or to except when it receives the instruction from the second device.

In Example 23, a system comprising: a first device, comprising a first receiver, configured to receive a first signal from a second device over a first connection, corresponding to a first channel; and a second receiver, configured to receive a second signal from the second device over a second connection, corresponding to a second channel; wherein the first receiver further comprises a first scrambler and a first block counter, each corresponding to the first connection, and wherein the second receiver further comprises a second scrambler and a second block counter, each corresponding to the second connection; the second device, comprising a transmitter, configured to send the first signal to the first receiver via the first connection and configured to send the second signal to the second receiver via the second connection; wherein the transmitter comprises a third device scrambler and a third block counter, each corresponding to the first connection, and wherein the transmitter further comprises a fourth device scrambler and a fourth block counter, each corresponding to the second connection; and wherein, in response to receiving an instruction from the second device to transition the second receiver from a low power state to an active state, the first device is configured to set the second scrambler based on a known relationship between the first scrambler and the second scrambler and to resolve or compensate for a skew based on a difference between the first block counter and the second block counter.

In Example 24, the system of Example 23, wherein the known relationship comprises a value of the first scrambler; initial seeds of the first scrambler and the second scrambler; and a skew between the first and second connection as detected at the second receiver based on a difference between the first block counter and the second block counter.

In Example 25, the first device of Example 24, wherein the instruction to transition the second connection from a low power state to an active state comprises a plurality of Electrical Idle Exit Ordered Set (EIEOS) transmissions.

In Example 26, the first device of Example 25, wherein the plurality of EIEOS transmissions comprises 2^{N} EIEOS transmission, wherein N is an integer.

In Example 27, the system of Example 26, wherein the instruction to transition the second connection from a low power state to an active state comprises four EIEOS transmissions followed by twenty-eight repetitions of a training sequence.

In Example 28, the system of any one of Examples 23 to 27, wherein the second device is further configured to begin its transmission of the instruction when a block counter of the second device equals zero.

In Example 29, the system of any one of Examples 23 to 28, wherein first device is configured to determine a block count of a block counter of the second device based on a timing of the instruction.

In Example 30, the system of any one of Examples 23 to 29, wherein the first block counter is configured with a first maximum block count that corresponds to a maximum expected skew, and wherein the second block counter is configured with a second maximum block count that corresponds to a maximum expected skew.

In Example 31, the first device of Example 30, wherein the first maximum block count corresponding to the maximum expected skew is the first maximum block count representing a duration that is at least twice the maximum expected skew of the first connection.

In Example 32, the system of any one of Examples 23 to 31, wherein the first block counter is configured to return to zero after reaching the first maximum block count, and wherein the second block counter is configured to return to zero after reaching the second maximum block count.

In Example 33, the system of any one of Examples 23 to 32, wherein the first device is further configured to determine a block count of a block counter of the second device based on a transmission received following the instruction.

In Example 34, the first device of Example 33, wherein a total duration of the transmission is equal to a total duration of the instruction to transition the second connection.

In Example 35, the system of Example 34, wherein the transmission comprises a repeated pattern of one Electrical Idle Exit Ordered Set followed by thirty-one repetitions of a training sequence.

In Example 36, the system of any one of Examples 23 to 35, wherein the first device being configured to resolve or compensate for the skew of the second connection based on the difference between the first block counter and the second block counter comprises the first device being configured to determine a value of the second scrambler based on a value of the first scrambler and an expected difference between a value of the first scrambler and a value of the second scrambler.

In Example 37, the system of Example 36, wherein the expected difference is based on a difference between a value of the first scrambler and a value of the second scrambler during a previous initialization.

In Example 38, the system of any one of Examples 23 to 37, wherein the first device resolving or compensating for the skew comprises the first device comparing a value of the first block counter and a value of the second block counter, and if the value of the first block counter is equal to the value of the second block counter, setting the second scrambler to correspond with a current value of the first scrambler.

In Example 39, the system of any one of Examples 23 to 38, wherein the first device resolving or compensating for the skew comprises the first device being configured to compare a value of the first block counter and a value of the second block counter, and setting the second scrambler to a value that is a predetermined number of states forward from a current value of the first scrambler if the value of the first block counter is greater than the value of the second block counter, and if the value of the first block counter minus the value of the second block counter is greater than one-half of an operation of one plus a maximum value of the second block counter.

In Example 40, the system of Example 39, wherein the predetermined number of states forward is 128*(a maximum block count of the second block counter−a current block count of the first block counter)+1).

In Example 41, the system of any one of Examples 23 to 40, wherein the first device resolving or compensating for the skew comprises the first device being configured to compare a value of the first block counter and a value of the second block counter, and setting the second scrambler to a value that is a predetermined number of states backward from a current value of the first scrambler if the value of the first block counter is greater than the value of the second block counter, and if the value of the first block counter minus the value of the second block counter is less than one-half of an operation of one plus a maximum value of the second block counter.

In Example 42, the system of Example 41, wherein the predetermined number of states backward is 128*(a value of the first block counter−a value of the first block counter).

In Example 43, a method of resolving a skew when transitioning from a low power state to an active state, the method comprising: receiving at a first receiver of a first device, a first signal from a second device over a first connection, corresponding to a first channel, and receiving at a second receiver of the first device, a second signal from the second device over a second connection, corresponding to a second channel; wherein the first receiver comprises a first scrambler and a first block counter, and wherein the second receiver comprises a second scrambler and a second block counter; and in response to receiving an instruction to transition the second receiver from a low power state to an active state, setting the second scrambler based on a known relationship between the first scrambler and the second scrambler, and resolving or compensating for a skew based on a difference between the first block counter and the second block counter.

In Example 44, the method of Example 43, wherein the instruction to transition the second receiver from the low power state to the active state comprises a plurality of Electrical Idle Exit Ordered Set (EIEOS) transmissions.

In Example 45, the method of Example 44, wherein the plurality of EIEOS transmissions comprises 2^{N} EIEOS transmission, wherein N is an integer.

In Example 46, the method of Example 44 or 45, wherein the instruction to transition the second receiver from the low power state to the active state comprises four EIEOS transmissions followed by twenty-eight repetitions of a training sequence.

In Example 47, the method of any one of Examples 43 to 46, further comprising determining a block count of a block counter of the second device based on a timing of the instruction.

In Example 48, the method of Example 47, wherein the determining of the block count of the block counter of the second device based on the timing of the instruction comprises the first device setting its second block counter to zero upon receiving the instruction.

In Example 49, the method of any one of Examples 43 to 48, wherein the first block counter is configured with a first maximum block count that corresponds to a maximum expected skew, and wherein the second block counter is configured with a second maximum block count that corresponds to a maximum expected skew.

In Example 50, the method of Example 49, wherein the first maximum block count corresponding to the maximum expected skew is the first maximum block count representing a duration that is at least twice the maximum expected skew.

In Example 51, the method of any one of Examples 43 to 50, further comprising returning the first block counter to zero after reaching the first maximum block count, and returning the second block counter to zero after reaching the second maximum block count.

In Example 52, the method of any one of Examples 43 to 51, further comprising determining a block count of a block counter of the second device based on a transmission received following the instruction.

In Example 53, the method of Example 52, wherein a total duration of the transmission is equal to a total duration of the instruction to transition the second connection.

In Example 54, the method of Example 53, wherein the transmission comprises a repeated pattern of one Electrical Idle Exit Ordered Set followed by thirty-one repetitions of a training sequence.

In Example 55, the method of any one of Examples 43 to 54, wherein resolving or compensating for the skew of the second connection based on the difference between the first block counter and the second block counter comprises determining a value of the second scrambler based on a value of the first scrambler and an expected difference between a value of the first scrambler and a value of the second scrambler.

In Example 56, the method of Example 55, wherein the expected difference is based on a difference between a value of the first scrambler and a value of the second scrambler during a previous initialization.

In Example 57, the method of any one of Examples 43 to 56, wherein the resolving or compensating for the skew of the second connection comprises comparing a value of the first block counter and a value of the second block counter, and if the value of the first block counter is equal to the value of the second block counter, setting the second scrambler to correspond with a current value of the first scrambler.

In Example 58, the method of any one of Examples 43 to 57, wherein the resolving or compensating for the skew of the second connection comprises comparing a value of the first block counter and a value of the second block counter, and setting the second scrambler to a value that is a predetermined number of states forward from a current value of the first scrambler if the value of the first block counter is greater than the value of the second block counter, and if the value of the first block counter minus the value of the second block counter is greater than one-half of an operation of one plus a maximum value of the second block counter.

In Example 59, the method of Example 58, wherein the predetermined number of states forward is 128*(a maximum block count of the second block counter−a current block count of the first block counter)+1).

In Example 60, the method of any one of Examples 43 to 59, wherein the resolving or compensating for the skew of the second connection comprises comparing a value of the first block counter and a value of the second block counter, and setting the second scrambler to a value that is a predetermined number of states backward from a current value of the first scrambler if the value of the first block counter is greater than the value of the second block counter, and if the value of the first block counter minus the value of the second block counter is less than one-half of an operation of one plus a maximum value of the second block counter.

In Example 61, the method of Example 60, wherein the predetermined number of states backward is 128*(a value of the first block counter−a value of the first block counter).

In Example 62, the method of any one of Examples 43 to 61, further comprising resetting the second block counter to zero upon receipt of a SKP OS transmission.

In Example 63, the method of any one of Examples 43 to 62, wherein the second block counter comprises a maximum block count; further comprising incrementing the second block counter upon receipt of a block, unless a current count of the second block counter equals the maximum block count, at which time the second block counter is configured to reset to zero, or to except when it receives the instruction from the second device.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A first device, comprising a first receiver, configured to receive a first signal from a second device over a first connection, corresponding to a first channel; and a second receiver, configured to receive a second signal from the second device over a second connection, corresponding to a second channel;
wherein the first receiver comprises a first scrambler and a first block counter, and wherein the second receiver comprises a second scrambler and a second block counter; and
wherein, in response to receiving an instruction to transition the second receiver from a low power state to an active state, the first device is configured to set the second scrambler based on a known relationship between the first scrambler and the second scrambler, and to resolve a skew between a first lane between the first receiver and a first transmitter of the first signal and a second lane between the second receiver and a second transmitter of the second signal based on a difference between the first block counter and the second block counter.

2. The first device of claim 0, wherein the known relationship comprises a value of the first scrambler; initial seeds of the first scrambler and the second scrambler; and a skew between the first and second connection as detected at the second receiver based on a difference between the first block counter and the second block counter.

3. The first device of claim 22, wherein the instruction to transition the second receiver from the low power state to the active state comprises a plurality of Electrical Idle Exit Ordered Set (EIEOS) transmissions; wherein the plurality of EIEOS transmissions consists comprises 2^{N} EIEOS transmission, wherein N is an integer.

4. The first device of claim 21, wherein the instruction to transition the second receiver from the low power state to the active state comprises four EIEOS transmissions followed by twenty-eight repetitions of a training sequence.

5. The first device of claim 0, wherein the first block counter is configured with a first maximum block count that corresponds to a maximum expected skew, and wherein the second block counter is configured with a second maximum block count that corresponds to the maximum expected skew.

6. The first device of claim 25, wherein the first maximum block count corresponding to the maximum expected skew is the first maximum block count representing a duration that is at least twice the maximum expected skew; wherein the first block counter is configured to return to zero after reaching the first maximum block count, and wherein the second block counter is configured to return to zero after reaching the second maximum block count.

7. The first device of claim 0, wherein the first device is further configured to determine a block count of a block counter of the second device based on a transmission received following the instruction.

8. The first device of claim 27, wherein a total duration of the transmission is equal to a total duration of the instruction to transition the second connection; and wherein the transmission comprises a repeated pattern of one Electrical Idle Exit Ordered Set followed by thirty-one repetitions of a training sequence.

9. The first device of claim 0, wherein the first device configured to resolve the skew of the second connection based on the difference between the first block counter and the second block counter comprises the first device configured to determine a value of the second scrambler based on a value of the first scrambler and an expected difference between a value of the first scrambler and a value of the second scrambler.

10. The first device of claim 29, wherein the expected difference is based on a difference between a value of the first scrambler and a value of the second scrambler during a previous initialization.

11. The first device of claim 0, wherein the first device resolving the skew of the second connection comprises the first device comparing a value of the first block counter and a value of the second block counter, and if the value of the first block counter is equal to the value of the second block counter, setting the second scrambler to correspond with a current value of the first scrambler.

12. The first device of claim 0, wherein the first device resolving the skew of the second connection comprises the first device configured to compare a value of the first block counter and a value of the second block counter, and setting the second scrambler to a value that is a predetermined number of states forward from a current value of the first scrambler if the value of the first block counter is greater than the value of the second block counter, and if the value of the first block counter minus the value of the second block counter is greater than one-half of an operation of one plus a maximum value of the second block counter.

13. The first device of claim 212, wherein the predetermined number of states forward is 128*(a maximum block count of the second block counter−a current block count of the first block counter)+1).

14. The first device of claim 0, wherein the first device resolving the skew of the second connection comprises the first device configured to compare a value of the first block counter and a value of the second block counter, and setting the second scrambler to a value that is a predetermined number of states backward from a current value of the first scrambler if the value of the first block counter is greater than the value of the second block counter, and if the value of the first block counter minus the value of the second block counter is less than one-half of an operation of one plus a maximum value of the second block counter.

15. The first device of claim 214, wherein the predetermined number of states backward is 128*(a value of the first block counter−a value of the first block counter).

16. The first device of claim 1, wherein the second block counter comprises a maximum block count, and wherein the second block counter is configured to increment upon receipt of a block, unless a current count of the second block counter equals the maximum block count, at which time the second block counter is configured to reset to zero, or to except when it receives the instruction from the second device.

1717. A system comprising:
a first device, comprising a first receiver, configured to receive a first signal from a second device over a first connection, corresponding to a first channel; and a second receiver, configured to receive a second signal from the second device over a second connection, corresponding to a second channel,
wherein the first receiver further comprises a first scrambler and a first block counter, each corresponding to the first connection, and wherein the second receiver further comprises a second scrambler and a second block counter, each corresponding to the second connection;
the second device, comprising a transmitter, configured to send the first signal to the first receiver via the first connection and configured to send the second signal to the second receiver via the second connection;
wherein the transmitter comprises a third device scrambler and a third block counter, each corresponding to the first connection, and wherein the transmitter further comprises a fourth device scrambler and a fourth block counter, each corresponding to the second connection; and
wherein, in response to receiving an instruction from the second device to transition the second receiver from a low power state to an active state, the first device is configured to set the second scrambler based on a known relationship between the first scrambler and the second scrambler and to resolve a skew of a first lane connected to the first receiver and a second lane connected to the second receiver based on a difference between the first block counter and the second block counter.

18. The system of claim 17, wherein the known relationship comprises a value of the first scrambler; initial seeds of the first scrambler and the second scrambler; and a skew between the first and second connection as detected at the second receiver based on a difference between the first block counter and the second block counter.

1919. A method, comprising:
receiving at a first receiver of a first device, a first signal from a second device over a first connection, corresponding to a first channel;
receiving at a second receiver of the first device, a second signal from the second device over a second connection, corresponding to a second channel, wherein the first receiver comprises a first scrambler and a first block counter, and wherein the second receiver comprises a second scrambler and a second block counter; and
in response to receiving an instruction to transition the second receiver from a low power state to an active state, setting the second scrambler based on a known relationship between the first scrambler and the second scrambler, and resolving a skew between a first lane connected to the first receiver and a second lane connected to the second receiver based on a difference between the first block counter and the second block counter.

20. The method of claim 19, wherein the instruction to transition the second receiver from the low power state to the active state comprises a plurality of Electrical Idle Exit Ordered Set (EIEOS) transmissions.
